(19) United States
(12) Patent Application Publication
(10) Pub. No.: US 2012/0084178 A1
(43) Pub. Date: Apr. 5, 2012

(54) Processing An Online Transaction Involving A Payment Service Provider

(75) Inventors: JOSEF EHBAUER, Weingarten (DE); RALF RUBEL, Gaggenau (DE); STEFAN TROEGER, Mannheim (DE); YANGNING PENG, Wiesloch (DE); GERO SCHULZ, Walldorf (DE); CHRISTOPH GERSTLE, Pirmasens (DE); CHRISTIAN KLUMPP, Karisruhe (DE); MARINA LAUMENIS, Karisruhe (DE); ANGELA KUBITZEK, Mannheim (DE); ALISSA RYZHOVA, Heidelberg (DE); MARCUS BOUWHUIS, Heidelberg (DE); MARTIN DAUER, Alsting (DE); GOKULA SUNDAR PONNUSAMY, Walldorf (DE)

(73) Assignee: SAP AG

(21) Appl. No.: 12/896,511

(22) Filed: Oct. 1, 2010

(51) Int. Cl. G06Q 30/00; G06Q 20/00

(52) U.S. Cl. 705/26.41

(57) ABSTRACT

A computer-implemented method for processing an online transaction involving a payment service provider includes receiving, in a backend system and from a frontend system, an initiate payment message generated by a user application for a transaction involving a payment service provider external to the frontend and backend systems. The method includes forwarding a set checkout instruction from the backend system to the payment service provider with first information about the transaction. The method includes redirecting the user application from the frontend system to the payment service provider. The method includes receiving a finalize payment instruction in the backend system from the frontend system after redirecting the user application from the frontend system. The method includes forwarding, in response to the finalize payment instruction, a perform checkout instruction from the backend system to the payment service provider with second information about the transaction.

### BACKGROUND

Payment service providers act in online environments as facilitators of financial transactions between a payer and a payee, for example when one or more customers purchase goods or services from a vendor. Payment service providers use different models for integration with the vendor system. Some customers have accounts with a payment service provider where they maintain their payment preferences such as credit or debit cards, bank accounts, etc. A web shop, for example, can offer one or more payment service providers for the customer to use. During the checkout process, the web shop customer selects the payment service provider for the payment. Some payment service providers offer account-less payment service to online customers. The payment service provider offers an HTML form that may be hosted on its server. During checkout, the customer enters the payment details into this form and the data is transmitted to the payment service provider. With some payment service providers, finally, payment details are entered and stored in the vendor or merchant's system, and transferred to the payment service provider for clearing.

Payment service providers use different technologies for communicating between their system and the vendor's system. For example, web services are offered by the payment service provider and consumed by the merchant system. As another example, payment service providers use data transfer via HTTP calls with POST and/or HTTP GET parameters from the online merchant to the payment service provider. Some payment service providers use data transfer also from the payment service provider back to the online merchant. As a final example, HTTP Redirects are used to transfer the online customer from the merchant to the payment service provider and back from the payment service provider site to the merchant.

### SUMMARY

This document describes examples of processing payments in an online scenario. As described below, a merchant designs an online commercial activity (such as a web shop), and selects one or more online payment services providers to handle the customers' payment for the goods or services. The merchant's system defines both a frontend component (e.g., the web shop accessible to the customer) and a backend component that handles the logistics and financial record keeping. The frontend and backend components individually interact with the payment service provider's system.

In a first aspect, a computer-implemented method for processing an online transaction involving a payment service provider includes receiving, in a backend system and from a frontend system, an initiate payment call triggered by a user application for a transaction involving a payment service provider external to the frontend and backend systems. The method includes forwarding a set checkout instruction from the backend system to the payment service provider with first information about the transaction. The method includes redirecting the user application from the frontend system to the payment service provider. The method includes receiving a finalize payment instruction in the backend system from the frontend system after redirecting the user application from the frontend system. The method includes forwarding, in response to the finalize payment instruction, a perform checkout instruction from the backend system to the payment service provider with second information about the transaction.

Implementations can include any or all of the following features. The method further includes: receiving, in the frontend system, a user selection of the payment service provider for the transaction; and modifying, in the backend system and in response to the user selection, an order regarding the transaction, including updating price data for the transaction. The method further comprises including in the set checkout instruction a return URL to the frontend system. The payment service provider triggers a redirection of the user application to the frontend system using the return URL, and wherein the finalize payment instruction is performed after the redirection The method further includes receiving, in the backend system, a message from the payment service provider that changes the transaction from pending to completed status, or from pending to rejected status.

The method further includes requesting, using the backend system and from the payment service provider, a status transition message for the transaction; and receiving, in the backend system, a message from the payment service provider in response to the request, the message changing the transaction from pending to completed status, or from pending to rejected status. In some implementations, the payment service provider sends the message to the frontend system, and the frontend system in response forwards the message to the backend system. In some implementations, the payment service provider sends the message directly to the backend system.

In a second aspect, a computer program product tangibly embodied in an information carrier includes instructions that when executed by a processor perform a method for processing an online transaction with a payment service provider. The method includes receiving, in a backend system and from a frontend system, an initiate payment call triggered by a user application for a transaction involving a payment service provider external to the frontend and backend systems. The method includes forwarding a set checkout instruction from the backend system to the payment service provider with first information about the transaction. The method includes redirecting the user application from the frontend system to the payment service provider. The method includes receiving a finalize payment instruction in the backend system from the frontend system after redirecting the user application from the frontend system. The method includes forwarding, in response to the finalize payment instruction, a perform checkout instruction from the backend system to the payment service provider with second information about the transaction.

Implementations can include any or all of the following features. The method further includes receiving, in the frontend system, a user selection of the payment service provider for the transaction; and modifying, in the backend system and in response to the user selection, an order regarding the transaction, including updating price data for the transaction. The method further comprises including in the set checkout instruction a return URL to the frontend system. The payment service provider triggers a redirection of the user application to the frontend system using the return URL, and wherein the finalize payment instruction is performed after the redirection. The method further includes receiving, in the backend system, a message from the payment service provider that changes the transaction from pending to completed status, or from pending to rejected status. The method further includes requesting, using the backend system and from the payment service provider, a status transition message for the transaction; and receiving, in the backend system, a message from the payment service provider in response to the request, the message changing the transaction from pending to completed status, or from pending to rejected status. The payment service provider triggers a redirection of the user application to the frontend, and wherein the finalize payment instruction is performed after the redirection.

In a third aspect, a system includes: at least one processor; and at least one computer-readable storage device including instructions that when executed cause the processor to generate at least a backend system and perform a method. The method includes receiving, in the backend system and from a frontend system, an initiate payment call triggered by a user application for a transaction involving a payment service provider external to the frontend and backend systems. The method includes forwarding a set checkout instruction from the backend system to the payment service provider with first information about the transaction. The method includes redirecting the user application from the frontend system to the payment service provider. The method includes receiving a finalize payment instruction in the backend system from the frontend system after redirecting the user application from the frontend system. The method includes forwarding, in response to the finalize payment instruction, a perform checkout instruction from the backend system to the payment service provider with second information about the transaction.

Implementations can include any or all of the following features. The system further includes an order management component in the backend system that modifies an order regarding the transaction, including updating price data for the transaction, the order modified in response to a user selection in the frontend system of the payment service provider for the transaction. The system further includes a billing component in the backend system that generates an invoice. The system further includes a financials component in the backend system that is updated upon invoicing of the order, receives a settlement file from the payment service provider, and matches the invoice with the settlement file. The set checkout instruction includes a return URL to the frontend system. The payment service provider triggers a redirection of the user application to the frontend system using the return URL, and wherein the finalize payment instruction is performed after the redirection.

Implementations can provide any or all of the following advantages: Processing of online payments can be performed more flexibly. Setup of an online vendor system can be simplified. Transactional systems can be made more useful for online commerce.

The details of one or more implementations are set forth in the accompanying drawings and the description below. Other features and advantages will be apparent from the description and drawings, and from the claims.

### DESCRIPTION OF DRAWINGS

FIG. 1 shows an example of a system for processing online transactions.

FIG. 2 shows examples of states for an online transaction.

FIG. 3 shows an example of an entity relationship model for use in processing online transactions.

FIG. 4 shows an example of a process flow in processing an online transaction.

FIG. 5 is a block diagram of a computing system that can be used in connection with computer-implemented methods described in this document.

Like reference symbols in the various drawings indicate like elements.

### DETAILED DESCRIPTION

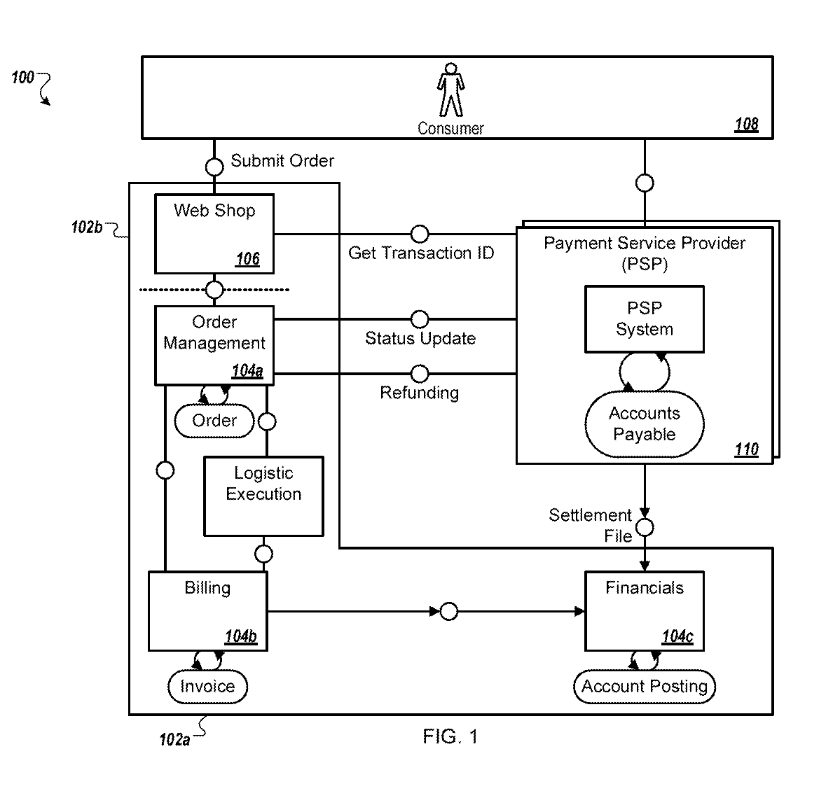

FIG. 1 shows an example of a system 100 for processing online transactions. In this implementation, the system 100 includes a customer relationship management (CRM) system 102 that comprises a backend system 102A and a frontend system 102B. The backend system 102A can include one or more transactional applications 104 and the front end 102B can include one or more online applications 102 that, for example, implement a web shop 106 for online shopping. The CRM system 102 can be implemented as one or more physical units, for example using at least one processor-based server device. Below will be described examples of how the system 100 can facilitate operations and communications between an online vendor and a payment service provider.

A consumer 108 is schematically shown as interacting with the system 100. The consumer 108 can be an individual, an organization or a system, to name a few examples, that uses the frontend system 102B for purchasing goods or services online. The consumer 108 can interact with the system 100 using any of a variety of technologies, such as a personal computer or a cellular phone, and the connection can be made over any kind of computer network (e.g., the internet).

The system 100 includes one or more payment service provider (PSP) systems 110 that can facilitate payment between the consumer 108 and the vendor or merchant of the CRM system 102. The consumer 108 may or may not have an account registered with the PSP system 110 for use in the transaction. The PSP system can be implemented using any suitable computer architecture, such as a server system. Illustrative examples of the PSP system 110 include, but are not limited to, the systems operated by the commercial entities PayPal, Click and Buy, Amazon Flexible Payments Service, Airplus, mpay24, Ogone, RBS World Pay, Bluepay, Paymetric, DataCash, and Intercard.

In some implementations, the web shop 106 includes a JAVA-based application, for example where the frontend system 102A is implemented using Web Channel technology from SAP AG. In such or other implementations, the backend system 102A can be a CRM backend system based on the ABAP programming language. For communication within or by the CRM backend system, ABAP Web Services can be used, and for communication of the front end 102B with the backend system 102A remote function calls (RFCs) can be used.

The following is an example of operations that can be performed in the system 100. The consumer 108 has initiated a purchase in the web shop 106 and is redirected from the front end system 102B to the PSP system 110. There, the consumer enters the specific payment method for a payment transaction (for example, credit card, direct debit, or electronic funds transfer). After confirmation from the PSP system 110, the consumer is returned back to the web shop 106. The backend system 102A adopts and records details of the payment transaction (e.g., identification and status) using at least the order management application 104A. The billing application 104B generates and maintains an invoice for the transaction. After fulfillment and invoicing of the order, the financials application 104C is updated. For example, the order is settled and the financials application processes a bank statement received from the PSP system 110 and automatically matches the open invoice with the payment transaction.

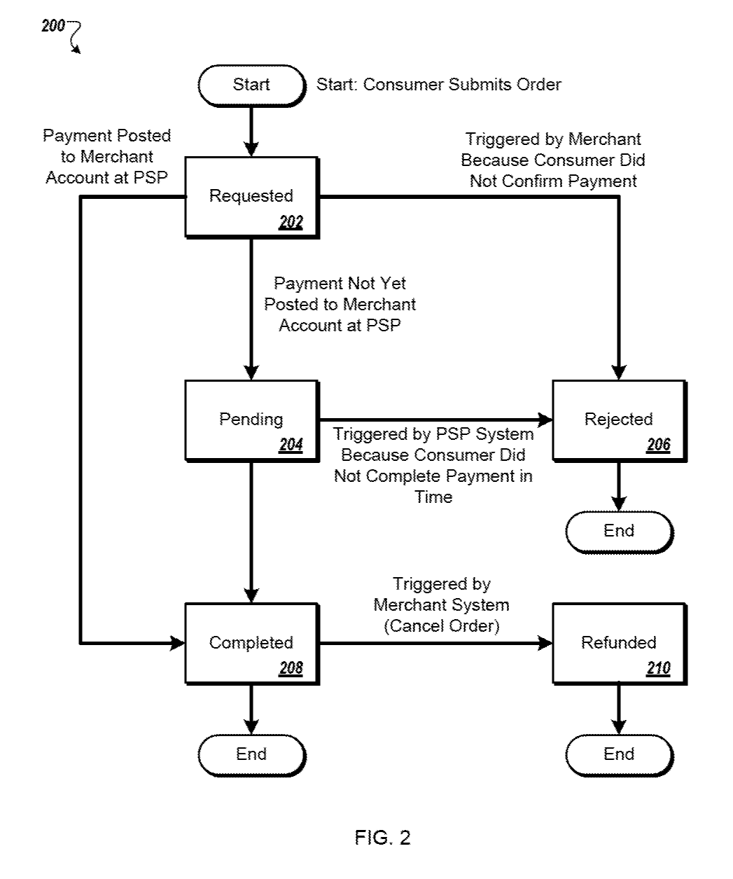

FIG. 2 shows examples of states for the payment of an online transaction. Here, a state diagram 200 includes illustrative states, including: a Requested state 202, a Pending state 204, a Rejected state 206, a Completed state 208 and a Refunded state 210. Briefly, the Requested state 202 can be triggered when a consumer submits an order for goods or services. While payment has not yet been posted to the vendor's account with the PSP, the Pending state 204 can occur. Instead, if the consumer does not confirm payment, the Rejected state 206 can be triggered.

From the Pending state 204, the PSP system can trigger a transfer to the Rejected state 206 because the consumer does not complete payment in time. Instead, if payment is posted to the vendor's account with the PSP, the Completed state 208 can occur. From the Completed state 208, the Refunded state 210 can be triggered by the backend system if the order is canceled. That is, in this implementation, each of the Completed state 208, Rejected state 206 and Refunded state 210 is a final state.

In some implementations, status transition from the Pending state 204 to the Completed state 208, or from the Pending state 204 to the Rejected state 206, can be triggered by the PSP system 110 using an instant payment notification that employs a “Push”-mechanism from the PSP system 110 to the CRM system 102. As another example, these transitions can be performed using a “Pull”-mechanism from the CRM system 102 to the PSP system, requesting the present state of the payment using a specific web service API. For example, the CRM system calls a pull method offered by the PSP, and receives the status of the transaction in response to the pull message. In some implementations, the owner or operator of the CRM system 102 (e.g., the vendor), creates a project-specific implementation for these transitions.

In some implementations, status transition from the Completed state 208 to the Refunded state 210 can be instructed only from the CRM system 102. The payment is then rejected on the PSP side and a subsequent refunding is initiated in the PSP system 110. This also leads to a subsequent settlement of the payment if the payment was already settled in the financials application 104C.

Some implementations follow the approach of “advance payment” processing. In such systems, a completed payment is a prerequisite for fulfillment of orders that involve the PSP system 110. The actual payment between the consumer's account and the merchant's account must happen at the PSP system 110 before the fulfillment of the order can happen. The time when the payment status is completed can depend on the payment method that the consumer chooses in the PSP system.

For example, with some PSPs a consumer moves cash from an account to the merchant's account, and the payment process is then completed immediately. In another example, the actual payment process can be completed at a different point in time, such as a few days later, and this is then reflected in the payment status. The backend system 102A, upon saving the order, sets a new payment status which indicates whether the order can be delivered and invoiced immediately (i.e., the Completed status 208), or order management must wait for the transition of payment status from the Pending status 204 to the Completed status 208.

While the status diagram 200 relates to payment status, as mentioned, the order or other transaction can have one or more status variables of its own. For example, Table 1 below describes aspects of some statuses that can apply to the order or transaction:

TABLE 1

| Status | Description | Meaning |
|---|---|---|
| Requested | Payment | Initial status which is only valid at run time |
| | has been | and necessary to distinguish between capturing |
| | requested | and confirmation of PSP-relevant orders. |
| Pending | Payment is | Initial status for PSP-relevant order which |
| | pending | indicates that further activity is needed on |
| | | PSP-side, i.e., the actual payment still needs |
| | | to be performed |
| Cancelled | Payment is | Final status which indicates that the payment is |
| | cancelled | cancelled. |

The payment status and the order/transaction status can differ from each other. For example, a transaction can have status “Payment Cancelled” whereas the payment status is “Refunded”.

In some implementations, the Requested status 202 allows selecting for orders where the capture process in the frontend system 102B failed, for example due to user abortion at the PSP system 110 or any technical communication issues. The Requested status 202 is deactivated after successful confirmation of order capturing.

In some implementations, the Pending status 204 controls, at a header level of the order in the backend system 102A, that no distribution occurs to the billing application 104B, and in a direct delivery scenario that a corresponding delivery object is not created in the backend system 102A. The Pending status 204 is deactivated when the transition from the Pending status 204 to the Completed status 208, or the transition from the Pending status 204 to the Rejected status 206, occurs.

In some implementations, shipping and invoicing are not performed during the Pending status 204. When the sales order has the Completed status 208, a delivery object can be created and invoicing can be carried out, either immediately or after an instant payment notification has been processed in the backend system 102A. As another example, the PSP system 110 does not initiate an instant payment notification but the backend system 102A pulls that information from the PSP system 110.

In some implementations, after transition from the Requested status 202 or the Pending status 204 to the Rejected status 206, the merchant must manually process the order further, for example to cancel the order or assign a different payment method (e.g., invoice) and order fulfillment trigger after removing logical blocks in the system that prevent delivery and billing.

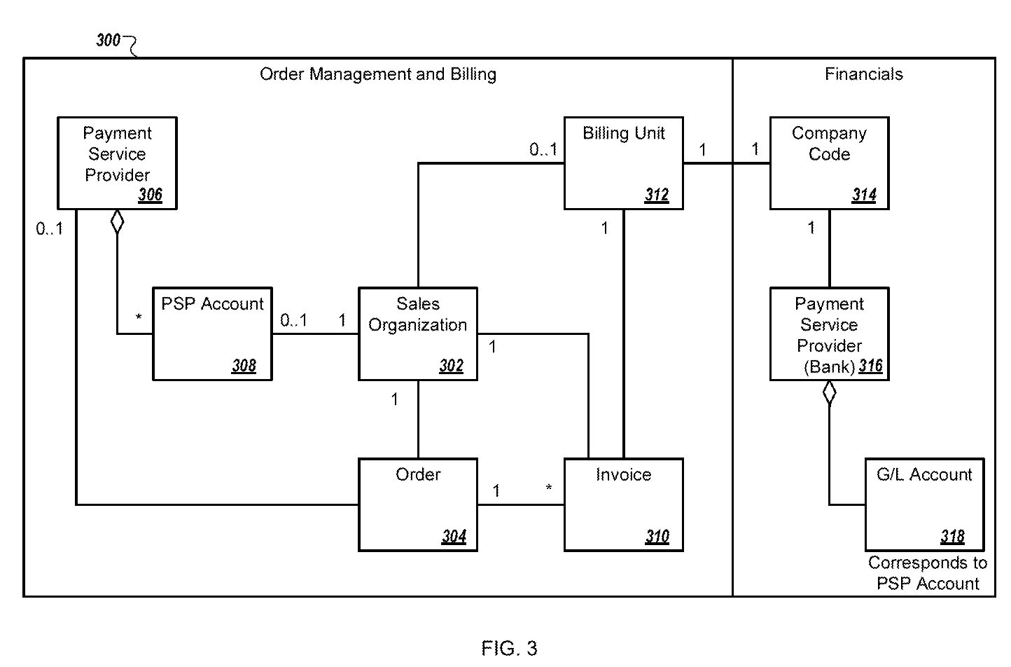

FIG. 3 shows an example of an entity relationship model 300 for processing online transactions. Lines between entities in the model 300 indicate relations between the entities. A line can be labeled with one or more numbers that indicate the cardinality for the particular relationship. For example, an Order 304 is bound to none or exactly one PSP 306; a Billing Unit 312 is bound to exactly one Company Code 314, and vice versa; and an Invoice 310 is bound to exactly one Billing Unit 312, for which many invoices can be processed.

The model 300 is here divided into parts corresponding to order management and billing on one hand, and financials on the other. For example, the order management application 104A and the billing application 104B can implement the former, and the financials application 104C can implement the latter.

The structure 300 specifies, first, a Sales Organization 302. For example, this represents the vendor. The structure 300 has an Order 304 that is bound to a particular PSP 306. For example, the PSP-relevant order can have a PSP identifier in the header. For the PSP 306 there can be a PSP account 308 that is also bound to the Sales Organization 302. For example, the PSP account 308 contains API logon information and message information for the vendor. An invoice 310 for the Order 304 is bound to a Billing unit 312, which in turn on the Financials side, is bound to a Company code 314 (e.g., a code or other identifier representing the vendor). The Company code 314 can be bound to a PSP 316 (e.g., a bank), which can be different from the PSP 306 servicing the consumer. The PSP 316 has a general ledger (G/L) account 318. In some implementations, the G/L account 318 corresponds to the PSP account 308.

Referring again to FIG. 1, in some implementations technical details of the communication between the system 100 (e.g., the CRM system 102) and PSPs is encapsulated in customized or otherwise tailored, separately implementable, code packages. This gives the CRM system 102 the flexibility to support multiple payment service providers, to hide PSP specifics behind a common interface, and can also give the consumer 108 the option to connect to potentially any PSP. For example, when the CRM system 102 includes a CRM solution from SAP AG, business add-ins (BAdIs) can be used. In some implementations, a vendor can create separate BAdI implementations in the CRM system 102 for every PSP.

In some implementations, the BAdIs or other forms of code packages cover the following functionality: Handle the payment processing for a sales order via the PSP. Start the payment process with the PSP when the consumer starts the checkout process and have selected a PSP as payment method. Handle the reversal of a payment made via the PSP when a sales order is cancelled; if a sales order is cancelled, any payment already made with a PSP needs to be refunded. Handle the import in the financials application 104C of a settlement file provided by the PSP; PSPs provide settlement files containing the history of settlements for a merchant account in a given time frame. For example, a BAdI method can be provided for mapping the format of the settlement file as provided by the PSP to the format needed in the financials application 104C.

In some implementations, code packages are created so all information that is needed to communicate with the PSP is for the most part available as parameter values. If the vendor needs access to additional fields of the sales order, the key of the order can also be passed in so that the order can be read in the BAdI implementation.

The following are examples of BAdI methods that can be used in implementations, for example in the system 100. In the explanations, the “vendor” is occasionally mentioned, and this should be understood as referring either to the actual vendor or to a party aiding the vendor with the system, such as a consultant or other professional.

INITIATE_TRANSACTION

This method is called when the consumer checks out and initiates the payment via a PSP. The implementation should handle the necessary communication with the PSP and trigger the redirection of the customer to the PSP's web site.

| Parameter | Type | Explanation |
|---|---|---|
| IS_REFERENCE_DOCUMENT | Structure | Identifies the sales order the |

| | | |
|---|---|---|
| OBJECT_KEY | SWO_TYPEID | payment is to be made for. This is |
| OBJECT_TYPE | SWO_OBJTYP | provided in case the vendor needs |
| LOGSYS | LOGSYS | to access attributes of the order that |

| | | |
|---|---|---|
| | | are not part of the BAdI interface. |
| IV_TRANSACTION_AMOUNT | WERTV8 | Total amount to be processed/paid. |
| IV_TRANSACTION_CURRENCY | WAERS | Currency key for |
| | | IV_TRANSACTION_AMOUNT |
| IS_SHIPPING_ADDRESS | ADDR1_DATA | Shipping address of the order. |
| IV_REFERENCE_GUID | RAW16 | This field is used as a technical |
| | | reference for the communication |
| | | with the PSP, and for the SAP |
| | | internal process integration from |
| | | order processing to billing to |
| | | accounting. Unlike |
| | | IV_REFERENCE_ID this field is |
| | | not expected to be visible to the |
| | | customer. |
| | | Before calling the BAdI method |
| | | this GUID is generated and |
| | | persisted as part of the sales order. |
| | | It should be transferred to the PSP |
| | | as is. |
| | | It is the vendor's responsibility to |
| | | verify that the reference ID and/or |
| | | the reference GUID passed to the |
| | | PSP are contained in the settlement |
| | | file of the PSP because at least one |
| | | of the references is needed for |
| | | matching the open receivables |
| | | against the records of the |
| | | settlement file. |
| IV_REFERENCE_ID | CHAR16 | This field is used as reference |
| | | number for the communication of |
| | | the vendor system with the PSP, |
| | | for the customer as well as for the |
| | | SAP internal process integration |
| | | from order processing to billing to |
| | | accounting. |
| | | The field is defaulted with the sales |
| | | order number when the BAdI is |
| | | called. The vendor has the option |
| | | to use this default or to overwrite it |
| | | with a different reference number |
| | | of their choice and return it with |
| | | the action |
| | | FINALIZE_TRANSACTION. |
| | | In any case, the value of the |
| | | reference number should be passed |
| | | on to the PSP as reference visible |
| | | to the customer. |
| | | It is the vendor's responsibility to |
| | | verify that the reference ID and/or |
| | | the reference GUID passed to the |
| | | PSP are contained in the settlement |
| | | file of the PSP because at least one |
| | | of the references is needed for |
| | | matching the open receivables |
| | | against the records of the |
| | | settlement file. |
| IV_WEC_SOURCE_URL | STRING | URL of the web shop that the |
| | | consumer is visiting when the |
| | | method is called; the consumer |
| | | should be redirected to this URL |
| | | by the PSP after confirming or |
| | | declining the payment on the PSL |
| | | web site. |
| | | For communicating with PayPal it |
| | | is expected that the BAdI |
| | | implementation determines the |
| | | return and cancel URLs by adding |
| | | an additional parameter to the |
| | | value of IV_WEC_SOURCE_URL. This |
| | | parameter can then be evaluated in |
| | | PROCESS_CALLBACK. |
| IT_KEY_VALUE | COM_WEC_PSP_NAME_{—} | Table of additional key/value pairs |
| | VALUE_TAB | that the customer can fill within |
| | | customer enhancements in the Java |
| | | layer and use for communication |
| | | with the PSP. |
| ER_ACTION | | Action parameter object |

PROCESS_CALLBACK

This method is called after whenever the PSP either redirects the consumer back to the frontend system 102B (after confirming or declining the payment on the PSP web site) or when the PSP otherwise calls a URL at the frontend system 102B (this can be used to simulate a merchant transaction script).

| Parameter | Type | Explanation |
|---|---|---|
| IS_REFERENCE_DOCUMENT | Structure | Identifies the sales order for |

| | | |
|---|---|---|
| OBJECT_KEY | SWO_TYPEID | which the payment is to be |
| OBJECT_TYPE | SWO_OBJTYP | made. This is provided in case |
| LOGSYS | LOGSYS | the vendor needs to access |

| | | |
|---|---|---|
| | | attributes of the order that are |
| | | not part of the BAdI interface. |
| IV_TRANSACTION_AMOUNT | WERTV8 | Total amount to be processed. |
| IV_TRANSACTION_CURRENCY | WAERS | Currency key for |
| | | IV_TRANSACTION_AMOUNT |
| IS_SHIPPING_ADDRESS | ADDR1_DATA | Shipping address of the order. |
| IV_REFERENCE_GUID | RAW16 | This field is used as a technical |
| | | reference for the communication |
| | | with the PSP, and for the SAP |
| | | internal process integration from |
| | | order processing to billing to |
| | | accounting. Unlike |
| | | CV_REFERENCE_ID this field |
| | | is not expected to be visible to |
| | | the customer. |
| | | Before calling the BAdI method |
| | | this GUID is generated and |
| | | persisted as part of the sales |
| | | order. |
| | | It is the vendor's responsibility |
| | | to verify that the reference ID |
| | | and/or the reference GUID |
| | | passed to the PSP are contained |
| | | in the settlement file of the PSP |
| | | because at least one of the |
| | | references is needed for |
| | | matching the open receivables |
| | | against the records of the |
| | | settlement file. |
| IV_REFERENCE_ID | CHAR16 | This field is used as reference |
| | | number for the communication |
| | | of the vendor system with the |
| | | PSP, for the customer as well as |
| | | for the SAP internal process |
| | | integration from order |
| | | processing to billing to |
| | | accounting. |
| | | The field is defaulted with the |
| | | sales order number when the |
| | | BAdI is called. The vendor has |
| | | the option to use this default or |
| | | to overwrite it with a different |
| | | reference number of their choice |
| | | and return it with the action |
| | | FINALIZE_TRANSACTION. |
| | | In any case, the value of the |
| | | reference number should be |
| | | passed on to the PSP as |
| | | reference visible to the customer. |
| | | It is the vendor's responsibility |
| | | to verify that the reference ID |
| | | and/or the reference GUID |
| | | passed to the PSP are contained |
| | | in the settlement file of the PSP |
| | | because at least one of the |
| | | references is needed for |
| | | matching the open receivables |
| | | against the records of the |
| | | settlement file. |
| IV_WEC_TARGET_URL | STRING | URL that was called by the PSP. |
| | | The PSP may append URL |
| | | parameters with transaction |
| | | details to this URL. |
| IT_PARAMETERS | COM_WEC_PSP_NAME_{—} | HTTP GET/POST parameters |
| | VALUE_TAB | passed in with |
| | | IV_TARGET_URL |
| IT_KEY_VALUE | COM_WEC_PSP_NAME_{—} | Table of additional key/value |
| | VALUE_TAB | pairs that the vendor can fill |
| | | using customer enhancements in |
| | | the Java layer and use for |
| | | communication with the PSP. |
| ER_ACTION | | Action parameter object |

CANCEL_TRANSACTION

This method is called when a sales order is cancelled and the payment is either voided or refunded. Some implementations include an executable program that allows the vendor to process this method periodically for many orders (e.g., by mass processing).

In another implementation, such as an implementation of the CRM system 102, cancelling the order will trigger a Post-Processing Framework (PPF) action which is processed asynchronously after the order has been cancelled. This decouples the cancellation of the order from the refunding process. One advantage of this is that in a communication failure the order can be cancelled and the refunding can be initiated again by reprocessing the PPF action. The method CANCEL_TRANSACTION will be executed from within the PPF action.

| Parameter | Type | Explanation |
|---|---|---|
| IS_REFERENCE_DOCUMENT | Structure | Identifies the sales order for which |

| | | |
|---|---|---|
| OBJECT_KEY | SWO_TYPEID | the cancellation is to be made. |
| OBJECT_TYPE | SWO_OBJTYP | This is provided in case the vendor |
| LOGSYS | LOGSYS | needs to access attributes of the |

| | | |
|---|---|---|
| | | order that are not part of the BAdI |
| | | interface. |
| IV_REFERENCE_GUID | RAW16 | This field is used as a technical |
| | | reference for the communication |
| | | with the PSP, and for the SAP |
| | | internal process integration from |
| | | order processing to billing to |
| | | accounting. |
| | | In the cancellation/refunding |
| | | process this number can be used to |
| | | find the transactions in the PSP |
| | | system that correspond to the sales |
| | | order being cancelled. |
| IV_REFERENCE_ID | CHAR16 | This field is used as reference |
| | | number for the communication of |
| | | the vendor system with the PSP, |
| | | for the customer as well as for the |
| | | SAP internal process integration |
| | | from order processing to billing to |
| | | accounting. |
| | | In the cancellation/refunding |
| | | process this number can be used to |
| | | find the transactions in the PSP |
| | | system that correspond to the sales |
| | | order being cancelled. |
| IV_PSP_TRANSACTION_ID | CHAR35 | Unique transaction ID that |
| | | identifies the transaction to be |
| | | cancelled in the PSP system. |
| ER_ACTION | | Action parameter object |

GET_TRANSACTION_DETAILS

This method is used to fetch the status of a payment transaction from the PSP. That status will subsequently be updated in the PSP transaction data in the CRM system 102. The method can serve one or both of the following purposes. First, the method can check the PSP transaction status for orders that have the status requested. Status requested implies that the user started the payment via the PSP for the order but the final confirmation from the PSP is missing, either because of an error when saving the order or because the user did not complete the process. If the user did complete the process the PSP will return a valid transaction status and the order can be updated with that status and thus be repaired. If the user did not complete the process the PSP will return an error indicating that the transaction is not known. The order can then be cancelled.

Second, the method can check the PSP transaction status for orders that have the status pending. Status pending implies that the payment process was completed but the PSP has not received the money yet.

| Parameter | Type | Explanation |
|---|---|---|
| IS_REFERENCE_DOCUMENT | Structure | Identifies the sales order the |

| | | |
|---|---|---|
| OBJECT_KEY | SWO_TYPEID | cancellation is to be made for. |
| OBJECT_TYPE | SWO_OBJTYP | This is provided in case the |
| LOGSYS | LOGSYS | vendor needs to access attributes |

| | | |
|---|---|---|
| | | of the order that are not part of |
| | | the BAdI interface. |
| IV_REFERENCE_GUID | RAW16 | This field is used as a technical |
| | | reference for the communication |
| | | with the PSP, and for the SAP |
| | | internal process integration from |
| | | order processing to billing to |
| | | accounting. |
| | | In the cancellation/refunding |
| | | process this number can be used |
| | | to find the transactions in the |
| | | PSP system that correspond to |
| | | the sales order being cancelled. |
| IV_REFERENCE_ID | CHAR16 | This field is used as reference |
| | | number for the communication |
| | | of the vendor system with the |
| | | PSP, for the customer as well as |
| | | for the SAP internal process |
| | | integration from order |
| | | processing to billing to |
| | | accounting. |
| | | In the cancellation/refunding |
| | | process this number can be used |
| | | to find the transactions in the |
| | | PSP system that correspond to |
| | | the sales order being cancelled. |
| IV_PSP_TRANSACTION_ID | CHAR35 | Unique transaction ID that |
| | | identifies the transaction to be |
| | | checked in the PSP system. |
| ER_ACTION | | Action parameter object |

### Action Parameters

The BAdI methods described above can have multiple output parameters for use in combination, but only certain combinations would be meaningful. The BAdIs can be extended when further scenarios are supported which would complicate the interface more. In order to make the interface easier to understand the BAdI methods will export an instance of an action object that contains all relevant parameters.

The parameter classes are structured in an inheritance hierarchy as follows:
CL_COM_WEC_PSP_INTEGR_PARAM (abstract)
   CL_COM_WEC_CREATE_TRANS_PARAM (abstract)
      CL_COM_WEC_INITIATE_TRANS
      CL_COM_WEC_FINALIZE_TRANS
      CL_COM_WEC_TRIGGER_REDIRECT
   CL_COM_WEC_CANCEL_TRANS_PARAM (abstract)
      CL_COM_WEC_FINALIZE_CANCEL
      CL_COM_WEC_REPROCESS_CANCEL
   CL_COM_WEC_UPDATE_TRANS_PARAM (abstract)
      CL_COM_WEC_UPDATE_TRANSACTION
      CL_COM_WEC_INVALIDATE_TRANS
      CL_COM_WEC_REPROCESS_UPDATE

Only the classes on the lowest level of the hierarchy are concrete classes that can be instantiated and returned from the BAdI methods.

Action CL_COM_INITIATE_TRANS

This action should be returned in case the communication with the PSP is to be restarted. This can be used in cases where a PSP is temporarily not reachable or in case of errors that prevent the continuation of the payment process with the selected PSP. The consumer is transferred back to the checkout page and can reselect the payment method. The action is usable for the BAdI methods INITIATE_TRANSACTION and PROCESS_CALLBACK.

| Parameter | Type | Explanation |
|---|---|---|
| MESSAGES | COMT_WEC_MESSAGES | Messages to be shown to the |
| | | end user on the UI |
| SYSLOG_MESSAGES | COMT_WEC_MESSAGES | Messages to be persisted in the |
| | | application log (to be used for |
| | | technical issues that have to be |
| | | looked into by an administrator). |

Action CL_COM_WEC_TRIGGER_REDIRECT

This action should be returned in case the customer is to be redirected to the web site of the PSP. The action is usable for the BAdI methods INITIATE_TRANSACTION and PROCESS_CALLBACK.

| Parameter | Type | Explanation |
|---|---|---|
| SYSLOG_MESSAGES | COMT_WEC_MESSAGES | Messages to be persisted in the |
| | | application log (to be used for |
| | | technical issues that have to be |
| | | looked into by an administrator). |
| TARGET_URL | STRING | Target URL of the PSP to which |
| | | the user is to be redirected |

Action CL_COM_WEC_FINALIZE_TRANS

This action should be returned in case the payment process is to be finalized and the order to be saved. The action is usable for the BAdI methods INITIATE_TRANSACTION and PROCESS_CALLBACK.

| Parameter | Type | Explanation |
|---|---|---|
| MESSAGES | COMT_WEC_MESSAGES | Messages to be shown to the |
| | | end user on the UI |
| SYSLOG_MESSAGES | COMT_WEC_MESSAGES | Messages to be persisted in the |
| | | application log (to be used for |
| | | technical issues that have to be |
| | | looked into by an administrator). |
| REFERENCE_ID | CHAR16 | This field is used as reference |
| | | number for the communication |
| | | of the vendor system with the |
| | | PSP, for the customer as well |
| | | as for the SAP internal process |
| | | integration from order |
| | | processing to billing to |
| | | accounting. |
| | | The proposal value is handed |
| | | into the method |
| | | INITIATE_TRANSACTION |
| | | as parameter |
| | | IV_REFERENCE_ID. |
| PSP_TRANSACTION_ID | CHAR35 | Unique transaction ID returned |
| | | by the PSP. This will be |
| | | persisted in the sales order for |
| | | documentation purposes. |
| TRANSACTION_STATUS_PROFILE | CHAR4 | Transaction status profile |
| TRANSACTION_STATUS | CHAR4 | Transaction status used to |
| | | control the follow-up |
| | | processing. |

Action CL_COM_WEC_FINALIZE_CANCEL

This action should be returned from the CANCEL_TRANSACTION method in case the refunding process with the payment service provider is completed and the order is to be updated accordingly.

| Parameter | Type | Explanation |
|---|---|---|
| MESSAGES | COMT_WEC_MESSAGES | Messages to be shown to the |
| | | end user on the UI |
| SYSLOG_MESSAGES | COMT_WEC_MESSAGES | Messages to be persisted in the |
| | | application log (to be used for |
| | | technical issues that have to be |
| | | looked into by an administrator). |
| PSP_TRANSACTION_ID | CHAR35 | Unique transaction ID returned |
| | | by the PSP. This will be |
| | | persisted in the sales order for |
| | | documentation purposes. |
| TRANSACTION_STATUS_PROFILE | CHAR4 | Transaction status profile |
| TRANSACTION_STATUS | CHAR4 | Transaction status used to |
| | | control the follow-up |
| | | processing. |

Action CL_COM_WEC_REPROCESS_CANCEL

This action should be returned from the CANCEL_TRANSACTION method in case the refunding process with the PSP could not be completed (because the transaction was pending and could not be refunded yet or because the PSP could not be reached). The system will preprocess the refunding process later.

| Parameter | Type | Explanation |
|---|---|---|
| MESSAGES | COMT_WEC_MESSAGES | Messages to be shown to the |
| | | end user on the UI |
| SYSLOG_MESSAGES | COMT_WEC_MESSAGES | Messages to be persisted in the |
| | | application log (to be used for |
| | | technical issues that have to be |
| | | looked into by an administrator). |
| PSP_TRANSACTION_ID | CHAR35 | Unique transaction ID returned |
| | | by the PSP. This will be |
| | | persisted in the sales order for |
| | | documentation purposes. |

Action CL_COM_WEC_UPDATE_TRANSACTION

This action should be returned from the GET_TRANSACTION_STATUS method in case the transaction is known at the PSP and the status of the transaction could be retrieved. The system will update the PSP data with the status returned.

| Parameter | Type | Explanation |
|---|---|---|
| MESSAGES | COMT_WEC_MESSAGES | Messages to be shown to the end |
| | | user on the UI |
| SYSLOG_MESSAGES | COMT_WEC_MESSAGES | Messages to be persisted in the |
| | | application log (to be used for |
| | | technical issues that have to be |
| | | looked into by an administrator). |
| PSP_TRANSACTION_ID | CHAR35 | Unique transaction ID returned |
| | | by the PSP. This will be |
| | | persisted in the sales order for |
| | | documentation purposes. |
| TRANSACTION_STATUS_PROFILE | CHAR4 | Transaction status profile |
| TRANSACTION_STATUS | CHAR4 | Transaction status used to control |
| | | the follow-up processing. |

Action CL_COM_WEC_INVALIDATE_TRANS

This action should be returned from the GET_TRANSACTION_STATUS method in case the transaction is not known at the PSP. The system will cancel the corresponding order because it has never been paid for.

| Parameter | Type | Explanation |
|---|---|---|
| MESSAGES | COMT_WEC_MESSAGES | Messages to be shown to the end |
| | | user on the UI |
| SYSLOG_MESSAGES | COMT_WEC_MESSAGES | Messages to be persisted in the |
| | | application log (to be used for |
| | | technical issues that have to be |
| | | looked into by an administrator). |

Action CL_COM_WEC_REPROCESS_UPDATE

This action should be returned from the GET_TRANSACTION_STATUS method in case the transaction status could not be retrieved from the PSP, for instance, because the PSP system could not be reached. The system will reprocess the status update later.

| Parameter | Type | Explanation |
|---|---|---|
| MESSAGES | COMT_WEC_MESSAGES | Messages to be shown to the end |
| | | user on the UI |
| SYSLOG_MESSAGES | COMT_WEC_MESSAGES | Messages to be persisted in the |
| | | application log (to be used for |
| | | technical issues that have to be |
| | | looked into by an administrator). |

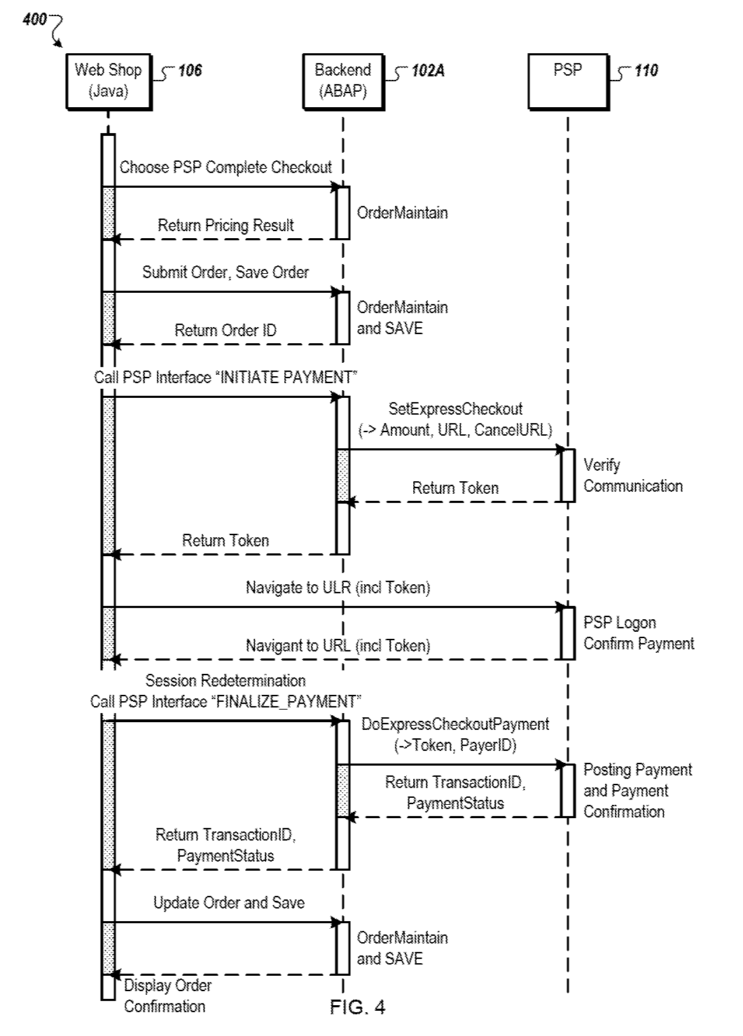

FIG. 4 shows an example of a process flow 400 in processing an online transaction. In this implementation, the process flow 400 involves the web shop 106, here implemented using JAVA code, the backend system 102A, here implemented using ABAP code, and the PSP 110. The payment service provider in this example in

PayPal.

After the user has chosen the PSP as payment method, the control is given back from a Payment business object (BO) to a Checkout BO.

The order in the backend system 102A is updated with the latest data before the submit button is pushed, so that pricing data are up to date.

If the user pushes the “Submit” button, the sales document is saved in the backend system 102A with the Requested status 202, and the PSP is stored in the corresponding database tables.

Afterwards, the Sales Document BO calls a Payment backend object (BE), which is a standalone BE providing all services to communicate with the backend 102A. The Payment BE calls an ABAP RFC to trigger the PSP Service Set up. The corresponding RFC Module COM_WEC_PSP_INITIATE resides in a reuse layer and is available in the CRM system 102.

The Function module COM_WEC_PSP_INITIATE calls the specific Implementation method INITIATE_PAYMENT of BAdI COM_WEC_PSP_INTEGRATION.

Finally, within this implementation, the web service method SetExpressCheckout of class CL_WEC_PSP_PAY_PAL_APIAAINTERFACE is called with the following data being passed on:

| Attribute | Mandatory | Description |
|---|---|---|
| ORDER_TOTAL- | X | Gross Value |
| CONTENT | | |
| ORDER_TOTAL- | X | Transaction Currency for Payment |
| CURRENCY_ID | | |
| RETURN_URL | X | URL that indicates where the user |
| | | shall return at the frontend system, |
| | | after completing the payment at the |
| | | PSP system; It comprises a static |
| | | part which is taken from the custom- |
| | | izing and the JAVA-Session ID as |
| | | dynamic part to control the navi- |
| | | gation from the PSP system to the |
| | | web shop 106 |
| CANCEL_URL | X | URL that indicates where the user |
| | | shall return at the frontend system, |
| | | after cancelling the payment at the |
| | | PSP system; The URL comprises a |
| | | static and a dynamic part. |
| INVOICE_ID | | Identifies the order in the PSP |
| | | system, and can be used for the |
| | | purpose of correspondence between |
| | | the consumer and the merchant: |
| | | With CRM orders the early document |
| | | numbering must be set up to catch |
| | | the order ID already at this point |
| | | in time |

In some implementations, the major part of the signature of the method is optional and only required if PayPal is used as checkout functionality.

If the SetExpressCheckout was successful, i.e., connection is in place and secure logon has been verified, the PSP system can return a token. This value may be needed to identify the opened session in the PSP system for the second step of communication. Returning the token to the front end 102B triggers the navigation for the redirection to the PSP system, via the PSP system's URL which may also include the token.

Return of a token by the PSP is optional. Some PSPs do not generate transaction identifiers. In some implementations the merchant generates a token and sends it to the PSP. In other implementations, a combination of both approaches, such that both the merchant and the PSP generate tokens, can be used.

If the consumer completes the payment, the consumer will be returned from the PSP system to an Order Confirmation View. This navigation is based on the RETURN_URL, which carries also the JAVA-session ID as a dynamic part. The temporary Session ID of the PSP system (i.e., the token) and the payer ID are also part of the RETURN_URL and must be used for the subsequent communication with the PSP system. The order confirmation, which is here handled by the web shop 106, is separate from any payment confirmation from the PSP.

Before the Order Confirmation View is displayed, the second communication step is triggered: The Payment BE calls the method FINALIZE_PAYMENT of BAdI COM_WEC_PSP_INTEGRATION to the CRM backend 102A via FM COM_WEC_PSP_FINALIZE. The method DoExpressCheckoutPayment of proxy class CL_WEC_PSP_PAY_PAL_APIAAINTERFACE is called synchronously, with the following data being passed on:

| Attribute | Mandatory | Description |
|---|---|---|
| PAYMEN_ACTION | X | Indicates with value “Sale” that the |
| | | 1-step process variant is applied |
| TOKEN | X | Session ID in the PSP system |
| PAYER_ID | X | Sold-to party |
| ORDER_TOTAL- | X | Gross value |
| CONTENT | | |
| ORDER_TOTAL- | X | Transaction currency for payment |
| CURRENCY_ID | | |
| SHIP_TO_{—} | X | Is required to guarantee the payment |
| ADDRESS | | |

The method will return the payment status (either Pending or Completed), and optionally, the transaction ID for the payment at the PSP system. In some implementations, the PSP does not generate a transaction identifier for return to the backend. For example, the token generated by the merchant system can be used as a transaction identifier.

This information is returned to the frontend system 102B to enable the presentation in the frontend layer.

In the web shop 106 the control is given back from the Payment BE to the Sales Document BO.

The Sales Document BO triggers the update of the order with the transaction ID and the payment status Pending or Completed, and the order is saved.

After saving, the order ID is returned to the web shop 106 to display the number in the frontend.

In some implementations, the consumer can decide to cancel the payment process also at the PSP system. Then the consumer is directed to the URL which is intended to handle further activities after cancellation. For example, the consumer can choose a different payment method (e.g., payment by invoice) to complete the checkout process. In this case the PSP-relevant data is initialized by the system with subsequent updating and saving of the order.

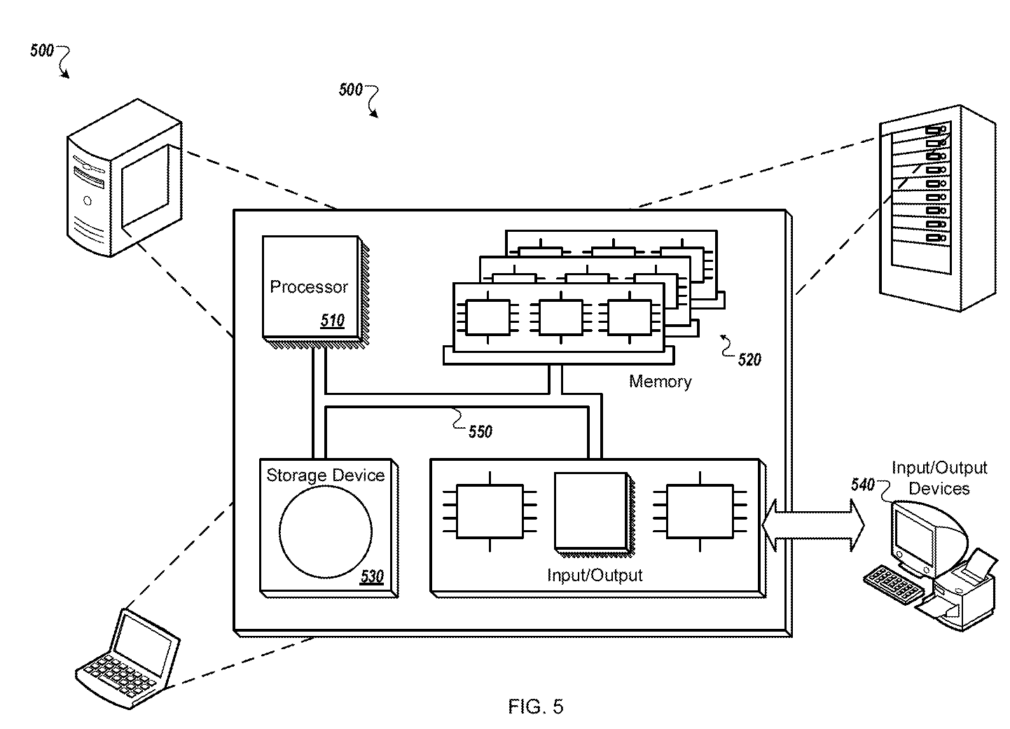

FIG. 5 is a schematic diagram of a generic computer system 500. The system 500 can be used for the operations described in association with any of the computer-implement methods described previously, according to one implementation. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. The memory 520 is a volatile memory unit in some implementations and is a non-volatile memory unit in other implementations.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of this disclosure. Accordingly, other implementations are within the scope of the following claims.

What is claimed is:

1. A computer-implemented method for processing an online transaction involving a payment service provider, the method comprising:
receiving, in a backend system and from a frontend system, an initiate payment call triggered by a user application for a transaction involving a payment service provider external to the frontend and backend systems;
forwarding a set checkout instruction from the backend system to the payment service provider with first information about the transaction;
redirecting the user application from the frontend system to the payment service provider;
receiving a finalize payment instruction in the backend system from the frontend system after redirecting the user application from the frontend system; and
forwarding, in response to the finalize payment instruction, a perform checkout instruction from the backend system to the payment service provider with second information about the transaction.

2. The computer-implemented method of claim 1, further comprising:
receiving, in the frontend system, a user selection of the payment service provider for the transaction; and
modifying, in the backend system and in response to the user selection, an order regarding the transaction, including updating price data for the transaction.

3. The computer-implemented method of claim 1, further comprising including in the set checkout instruction a return URL to the frontend system.

4. The computer-implemented method of claim 3, wherein the payment service provider triggers a redirection of the user application to the frontend system using the return URL, and wherein the finalize payment instruction is performed after the redirection.

5. The computer-implemented method of claim 1, further comprising:
receiving, in the backend system, a message from the payment service provider that changes the transaction from pending to completed status, or from pending to rejected status.

6. The computer-implemented method of claim 1, further comprising:
requesting, using the backend system and from the payment service provider, a status transition message for the transaction; and
receiving, in the backend system, a message from the payment service provider in response to the request, the message changing the transaction from pending to completed status, or from pending to rejected status.

7. The computer-implemented method of claim 6, wherein the payment service provider sends the message to the frontend system, and the frontend system in response forwards the message to the backend system.

8. The computer-implemented method of claim 6, wherein the payment service provider sends the message directly to the backend system.

9. A computer program product tangibly embodied in an information carrier and comprising instructions that when executed by a processor perform a method for processing an online transaction with a payment service provider, the method comprising:
receiving, in a backend system and from a frontend system, an initiate payment call triggered by a user application for a transaction involving a payment service provider external to the frontend and backend systems;
forwarding a set checkout instruction from the backend system to the payment service provider with first information about the transaction;
redirecting the user application from the frontend system to the payment service provider;
receiving a finalize payment instruction in the backend system from the frontend system after redirecting the user application from the frontend system; and
forwarding, in response to the finalize payment instruction, a perform checkout instruction from the backend system to the payment service provider with second information about the transaction.

10. The computer program product of claim 9, the method further comprising:
receiving, in the frontend system, a user selection of the payment service provider for the transaction; and
modifying, in the backend system and in response to the user selection, an order regarding the transaction, including updating price data for the transaction.

11. The computer program product of claim 9, the method further comprising:
including in the set checkout instruction a return URL to the frontend system.

12. The computer program product of claim 11, wherein the payment service provider triggers a redirection of the user application to the frontend system using the return URL, and wherein the finalize payment instruction is performed after the redirection.

13. The computer program product of claim 9, the method further comprising:
receiving, in the backend system, a message from the payment service provider that changes the transaction from pending to completed status, or from pending to rejected status.

14. The computer program product of claim 9, the method further comprising:
requesting, using the backend system and from the payment service provider, a status transition message for the transaction; and
receiving, in the backend system, a message from the payment service provider in response to the request, the message changing the transaction from pending to completed status, or from pending to rejected status.

15. A system comprising:
at least one processor; and
at least one computer-readable storage device including instructions that when executed cause the processor to generate at least a backend system and perform a method comprising:
receiving, in the backend system and from a frontend system, an initiate payment call triggered by a user application for a transaction involving a payment service provider external to the frontend and backend systems;
forwarding a set checkout instruction from the backend system to the payment service provider with first information about the transaction;
redirecting the user application from the frontend system to the payment service provider;
receiving a finalize payment instruction in the backend system from the frontend system after redirecting the user application from the frontend system; and
forwarding, in response to the finalize payment instruction, a perform checkout instruction from the backend system to the payment service provider with second information about the transaction.

16. The system of claim 15, further comprising:
an order management component in the backend system that modifies an order regarding the transaction, including updating price data for the transaction, the order modified in response to a user selection in the frontend system of the payment service provider for the transaction.

17. The system of claim 16, further comprising:
a billing component in the backend system that generates an invoice.

18. The system of claim 17, further comprising:
a financials component in the backend system that is updated upon invoicing of the order, receives a settlement file from the payment service provider, and matches the invoice with the settlement file.

19. The system of claim 15, wherein the set checkout instruction includes a return URL to the frontend system.

20. The system of claim 19, wherein the payment service provider triggers a redirection of the user application to the frontend system using the return URL, and wherein the finalize payment instruction is performed after the redirection.
